(19) United States
(12) Patent Application Publication
(10) Pub. No.: US 2011/0101635 A1
(43) Pub. Date: May 5, 2011

(54) ONE-HAND OPERATION CONVERSION AND TORQUE CONTROLLER FOR WHEELBARROW HANDLES

(76) Inventor: Stephen Walter Sepeck, III, Dayton, OH (US)

(21) Appl. No.: 12/611,153

(22) Filed: Nov. 3, 2009

(51) Int. Cl. B62B 1/00

(52) U.S. Cl. 280/47.31

(57) ABSTRACT

The “ONE-HAND OPERATION CONVERSION AND TORQUE CONTROLLER FOR WHEELBARROW HANDLES” added to a wheelbarrow, on one hand, offers single hand operability and maneuverability, and on the other hand offers added benefits to dual-handed users. The wheelbarrow can easily be converted from dual to single-handed operation and then back again with this said unit. This is completed by adding a centrally mounted handle to cross support(s) which are attached to the two longitudinally extending handles of the said wheelbarrow. When the center handle is attached, one-hand operation is achieved by the load balancing capabilities of the said handle and its mounting orientation. The center handle is formed into or mounted to the cross support(s) that are mounted or formed into the existing longitudinal handles. The unit size dimensions and mounting method are arbitrary and will be made to fit the circumstances of mounting position and cross support material. The cross support(s) material and the handle material are of variable rigid form. The cross support mounts are variably rigid and can be adapted to fit the form of the said cross support(s) as well as conformed to the shape of the said wheelbarrows longitudinal handles. The cross support(s) offer the user an ergonomically padded contact area. This contact area can be used to apply a force by means of the upper thigh area when the wheelbarrow is in use under heavy load. While under heavy load a user is often subjected to high stresses by the wheelbarrow under tipping conditions and this creates a torque to reside between the users' hands/arms and the wheelbarrow handles. In order to help overcome this moment affect, the wheelbarrow cross member(s) handle conversion kit has been extended to offer increased torque and roll control. These said extensions are either in line, above, below or in some relative angle of placement to the center mounted cross support(s).

### CROSS-REFERENCE TO RELATED APPLICATIONS

Ser. No. 11/158,977

### SEQUENCE LISTING

None

### REFERENCES CITED

```
7,434,818 to Sepeck III, S. W.
  102,376 to Dederick, P. K;
  175,069 to Gandola, Frank V;
  618,900 to Oakey, W. V;
  676,163 to Victor, D;
  961,719 to Hubbard, A. O;
1,095,145 to Elterich, D;
1,312,990 to Johnson, C. B;
1,516,856 to Johnson, C. B;
2,494,199 to Provitola, Anthony and Anna T;
2,660,446 to Edhardt, G. E;
2,672,348 to Scott, R. W;
3,262,713 to Crawford Sr, J;
3,404,427 to Mack, W. V;
4,230,329 to Johnson, Aldus;
4,252,334 to Filkins, Steven J;
4,270,786 to Mattox, McKinley;
4,444,405 to Barrus, Dwight M;
4,471,996 to Primeau, Mario;
4,666,170 to Vasa, Jiri;
4,740,008 to Johnson, James A;
4,758,010 to Christie, Howard C;
4,767,128 to Terhune, John J;
4,789,171 to Porter, Lynn L;
4,854,601 to Herndon, George W;
5,031,926 to Wannamaker, David D;
5,149,116 to Donze, et al;
5,305,843 to Armstrong, Leonard J;
5,350,030 to Mawhinney, et al;
5,458,356 to Fedorko, et al;
5,564,722 to Cimo, Richard T;
5,758,887 to Bobst, Glen L;
5,810,375 to Hoffarth, et al;
5,884,924 to Fairchild, et al;
5,906,381 to Hovatter, Steven;
5,915,706 to Mosley, Keith A;
5,924,708 to Bisaillon, et al;
6,017,053 to Leger, et al;
6,039,333 to Hamblin, Steven Lee;
6,065,555 to Yuki, et al;
6,161,850 to James, et al;
6,173,799 to Miyazaki, et al;
6,220,622 to Garcia, Guadalupe;
6,488,130 to Bermel, John Karl;
6,550,104 to Cacciacarne, Ernest D;
6,685,198 to Hartman, Donald Dewayne;
6,755,478 to Messinger-Rapport, Kenneth H;
6,820,880 to Benton, Nick Charles;
6,886,838 to Zimmerman, Felton;
6,908,088 to Feick, William Kurt;
6,945,545 to Celli, Giuliano;
7,032,718 to Lessard, Maurice;
7,077,404 to Groskreutz, Donald A;
7,121,565 to Lulay, Melvin F;
7,104,565 to Albert, et al;
7,134,675 to Carosi, et al;
5,346,232 to Bushon; Richard
```

### FIELD OF THE INVENTION

The invention relates to a convertible vehicle for hauling material and in particular, a barrow-type vehicle which can be adapted by adding a handle system providing a single handle for usability and maneuverability of the said wheelbarrow and offering extra maneuverability of the said wheelbarrow when tipping control and added torque control is needed.

### PRIOR ART

Wheelbarrows are known to be either one wheeled or multi-wheeled devices with attached handlebars spaced apart and a storage compartment to carry objects. The operator using two hands to control the wheelbarrows exact movement is oriented behind and is pushing the said wheelbarrow. The wheelbarrow in resting position is supported by two legs or wheels located at the back of the said vehicle. The front of the vehicle is supported by either one or more wheels. The operator uses the two handles to lift and maneuver the wheelbarrow to other destinations.

Such wheelbarrows have been adapted for easier use with two hands, but none have added ergonomic benefits, or have been accommodated for the operation and maneuverability with a single hand. There is also an issue related to extra control of the said wheelbarrow when it is in the process of tipping and losing its loaded compartment contents. In order to overcome this, an extra benefit has been added to the cross supports(s) construction in overall length aspects to overcome and control wheelbarrow roll-overs.

### SUMMARY OF THE INVENTION

This invention eliminates the necessity for dual handed control of a single or multi-wheeled wheelbarrow, it offers two-hand users an additional ergonomic benefit, and it allows users to better control the wheelbarrow if its center of balance is overcome. Wheelbarrows deal mainly with the transportation of materials (earth, blocks, etc.); in general the movement of mass amounts of material. The originally designed wheelbarrow handles require two-handed operation. The described system herein makes this two-hand operated wheelbarrow operable with one-hand, extends the users torque and rotation control, and gives added ergonomic force application benefits. This said system deals with the wheelbarrows usability and maneuverability aspects and it will help disabled (arm paralysis, cane users, etc. . . . ) individuals with its operation. It will also make it easier for normal individuals to carry objects and maneuver the wheelbarrow by offering ergonomic benefits, added roll-over control, and offers the user a free hand during operation. The cross support(s) adds ergonomic benefits by creating a new area for force application and load support, this force and load now is partly placed on the upper thigh of the users' body when the wheelbarrow is in operation. Thus, decreasing the arm abduction propensity and decreasing the tendency to develop musculoskeletal injuries during use.

This invention adds a single handle operating system to the dual longitudinal handles protruding from the wheelbarrow. This centrally mounted handle can have extended lengths, it can be padded and it attaches to or is built within the cross support(s) that are affixed or built into the handles of the wheelbarrow using support mounts or formed as an all inclusive member. The handle system itself is a convertible device which can be removed, folded, or pushed away into a storage position when normal wheelbarrow handle operation is needed.

### ADVANTAGES OF THE

As can be easily seen, this invention offers the ability of usability. It gives an individual with limited mobility the chance to operate a mechanical device once only operable with two hands. This device not only offers a handle system for one-handed use, but it also provides cross support(s) that can be padded and used as a force application point for applying extra power using the upper thigh area to move heavy objects and decrease the load on the upper body (shoulders, wrists, hands and spine). The center handle can be extended to offer added roll control, attached and detached, folded and stored, or pushed out of the way. The cross support(s) and/or extensions offer the ability to control the load moment placed on them by their individual design characteristics, lengths, mounting placement and mounting hardware.

### BRIEF DESCRIPTION OF THE DRAWINGS

FIG. 1 is a detailed perspective left side view of the wheelbarrow with the dual cross support handle system installed.

FIG. 2 is an unattached exploded and detailed perspective view of the dual cross support handle system.

FIG. 3 is a perspective left side view of a wheelbarrow with a single cross support handle system installed.

FIG. 4 is an unattached exploded and detailed perspective view of the single cross support handle system.

FIG. 5 is a detailed perspective left side view of the wheelbarrow with the single extended cross support handle system installed.

FIG. 6a is an unattached exploded and detailed perspective view of the single extended cross support handle system.

FIG. 6b is an unattached orientation perspective of the extended handle location.

FIG. 7 is a perspective left side view of a wheelbarrow with a dual-stacked and extended cross support handle system installed.

FIG. 8 is an unattached exploded and detailed perspective view of the dual-stacked and extended cross support handle system.

FIG. 9 is a perspective left side view of a wheelbarrow with a dual-stacked, extended and support reinforced cross support handle system installed.

FIG. 10 is an unattached exploded and detailed perspective view the dual-stacked, extended and support reinforced cross support handle system.

### DETAILED DESCRIPTION OF THE DRAWINGS

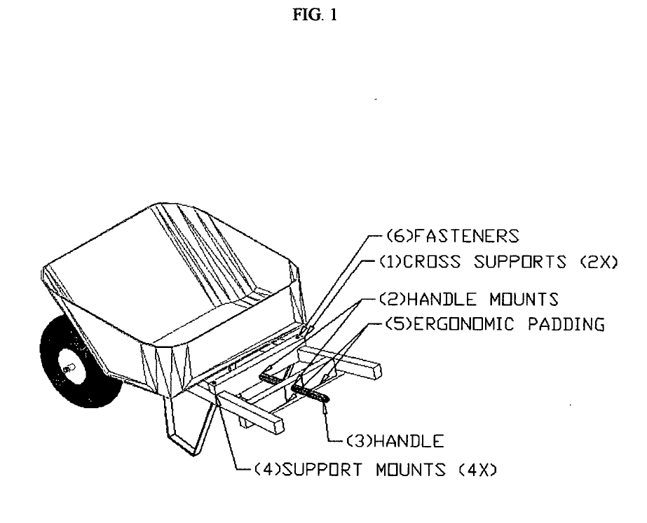

FIG. 1 is a detailed perspective view of the wheelbarrow with the dual cross support system installed. The cross support system is shown mounted to the original handles supplied with the wheelbarrow. The (1) CROSS SUPPORTS are made of variable rigidity, can be scaled in size to withstand desired load requirements, can have (5) ERGONOMIC PADDING and are mounted arbitrarily with (4) SUPPORT MOUNTS to the wheelbarrows handles with (6) FASTENERS. The center (3) HANDLE is made of variable rigidity, can be scaled in size upon manufacture to withstand desired load requirements and is mounted to the cross supports with (2) HANDLE MOUNTS in a placement causing the load of the two wheelbarrow handles to be placed upon said center handle.

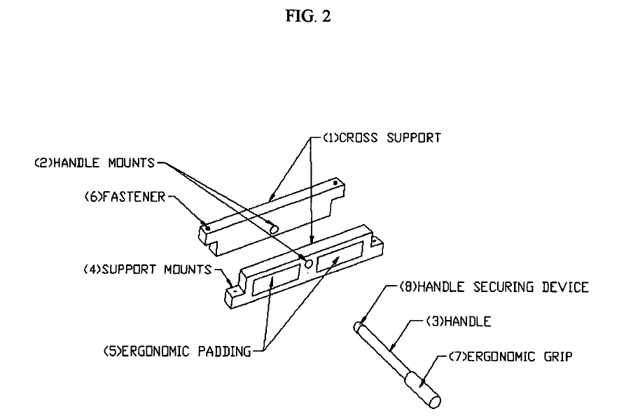

FIG. 2 is a detailed isometric exploded view of the dual cross support system, this view shows the unit exploded and separated from the wheelbarrow handles. The (1) CROSS SUPPORTS are made of variable rigidity, can be scaled in size to withstand desired load requirements, can have (5) ERGONOMIC PADDING and are mounted arbitrarily with (4) SUPPORT MOUNTS to the wheelbarrows handles with (6) FASTENERS. The center (3) HANDLE is made of variable rigidity, can be scaled in size upon manufacture to withstand desired load requirements, is mounted to the cross supports with (2) HANDLE MOUNTS, secured in place with (8) HANDLE SECURING DEVICE, and can be configured with an (7) ERGONOMIC GRIP. The placement of the handle system causes the load of the two wheelbarrow handles to be placed upon said center handle.

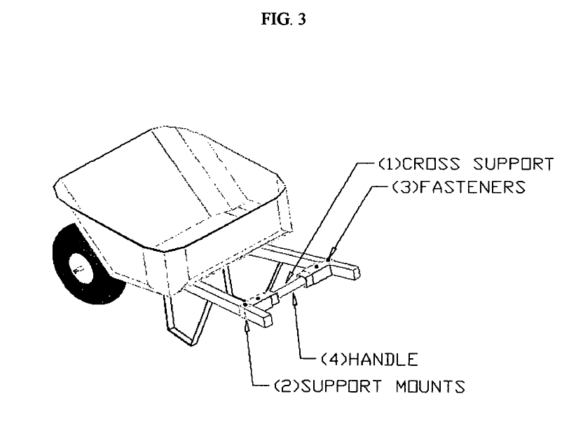

FIG. 3 is a detailed perspective drawing of the wheelbarrow with the unit installed using a single cross support. The handle conversion unit is shown mounted to the original handles supplied with the wheelbarrow. The (1) CROSS SUPPORT is made of variable rigidity, can be scaled in size to withstand desired load requirements and it is fastened arbitrarily using (2) SUPPORT MOUNTS to the wheelbarrows handles with (3) FASTENERS. The center (4) HANDLE is formed into the said (1) CROSS SUPPORT.

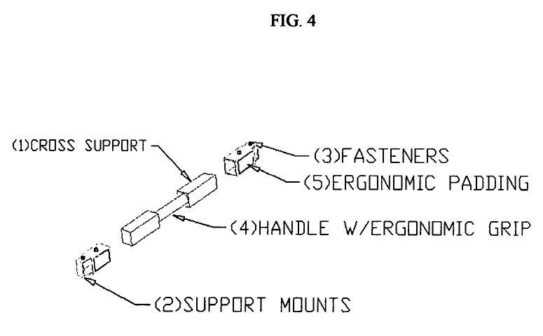

FIG. 4 is a detailed isometric exploded view of the single cross support system, this view shows the unit exploded and separated from the wheelbarrow handles. The (1) CROSS SUPPORT is made of variable rigidity, can be scaled in size to withstand desired load requirements, can have (5) ERGONOMIC PADDING and is mounted arbitrarily with (2) SUPPORT MOUNTS to the wheelbarrows handles with (3) FASTENERS. The center (4) HANDLE is formed into the (1) CROSS SUPPORT, can be scaled in size upon manufacture to withstand desired load requirements, is mounted to the cross supports with (2) SUPPORT MOUNTS, is secured in place with (8) HANDLE SECURING DEVICE, and can be configured with an ERGONOMIC GRIP. The placement of the handle system causes the load of the two wheelbarrow handles to be placed upon said center handle.

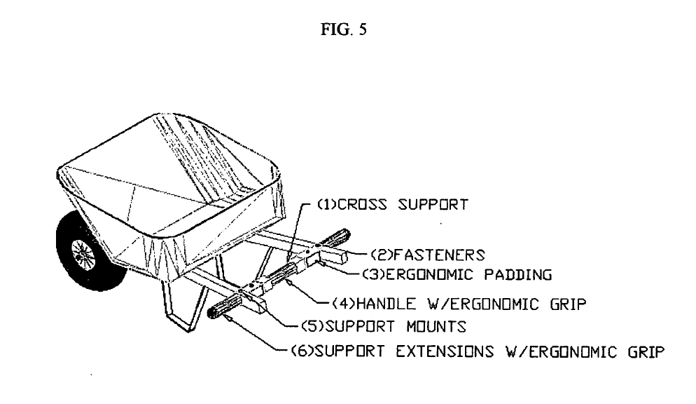

FIG. 5 is a detailed perspective drawing of the wheelbarrow with the unit installed using a single extended cross support. The handle conversion unit is shown mounted to the original handles supplied with the wheelbarrow. The (1) CROSS SUPPORT is made of variable rigidity, can be scaled in size to withstand desired load requirements and it is fastened arbitrarily using (2) SUPPORT MOUNTS to the wheelbarrows handles with (3) FASTENERS. The center (4) HANDLE is formed into the said (1) CROSS SUPPORT and the (6) SUPPORT EXTENSIONS W/ERGONOMIC GRIP or WITHOUT GRIP are either formed into the (1) CROSS SUPPORT or are mounted to the (2) SUPPORT MOUNTS.

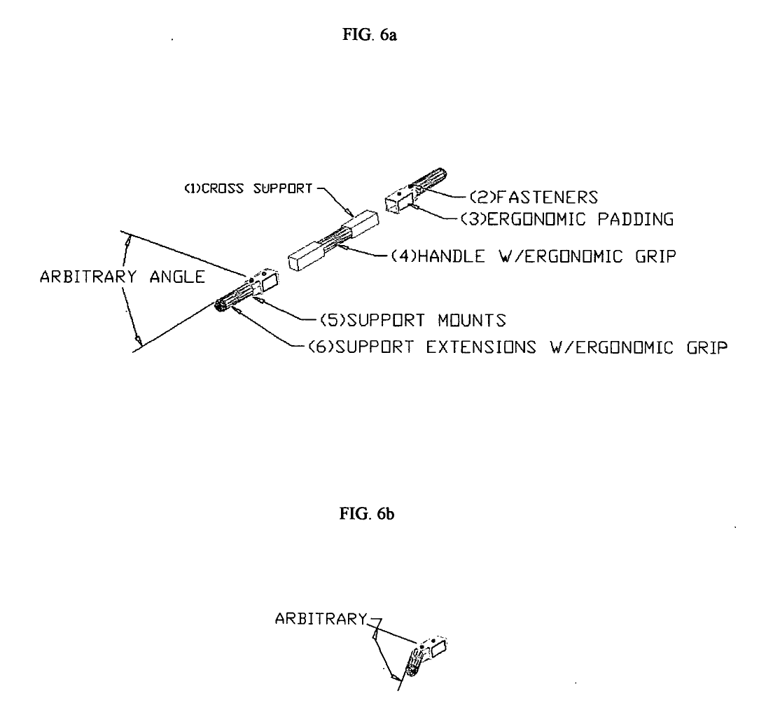

FIG. 6a is a detailed isometric exploded view of the single extended cross support system, this view shows the unit exploded and separated from the wheelbarrow handles. The (1) CROSS SUPPORT is made of variable rigidity, can be scaled in size to withstand desired load requirements, can have (5) ERGONOMIC PADDING and is mounted arbitrarily with (2) SUPPORT MOUNTS to the wheelbarrows handles with (3) FASTENERS. The center (4) HANDLE is formed into the said (1) CROSS SUPPORT and the (6) SUPPORT EXTENSIONS W/ERGONOMIC GRIP or WITHOUT GRIP are either formed into the (1) CROSS SUPPORT or are added to the (2) SUPPORT MOUNTS and set at an arbitrary angle relative to design requirements.

FIG. 6b is a detail isometric exploded auxiliary view of the (1) SUPPORT EXTENSIONS W/ERGONOMIC GRIP or WITHOUT GRIP relative angle of placement which can configure and locate the extended handle spherically around its (5) SUPPORT MOUNTS shown in FIG. 6a.

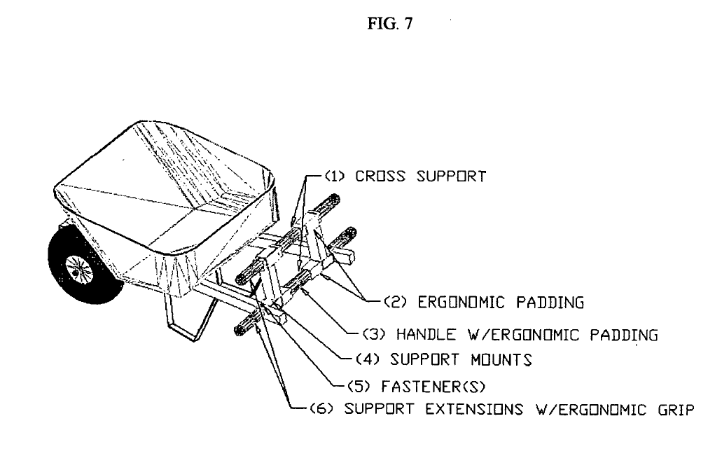

FIG. 7 is a detailed perspective drawing of the wheelbarrow with the unit installed using a dual-stacked and extended cross support. The dual-stacked and extended conversion unit is shown mounted to the original handles supplied with the wheelbarrow and can be covered with (2) ERGONOMIC PADDING. The stacked (1) CROSS SUPPORT is made of variable rigidity, can be scaled in size to withstand desired load requirements, is located at an arbitrary angle to the wheelbarrow handles and it is fastened arbitrarily using (4) SUPPORT MOUNTS to the wheelbarrows handles with (5) FASTENERS. The center (3) HANDLE W/ERGONOMIC PADDING is formed into the said (1) CROSS SUPPORT and the (6) SUPPORT EXTENSIONS W/ERGONOMIC GRIP are either formed into the (1) CROSS SUPPORT, added to the (2) SUPPORT MOUNTS, or are fabricated and formed into the wheelbarrow handles.

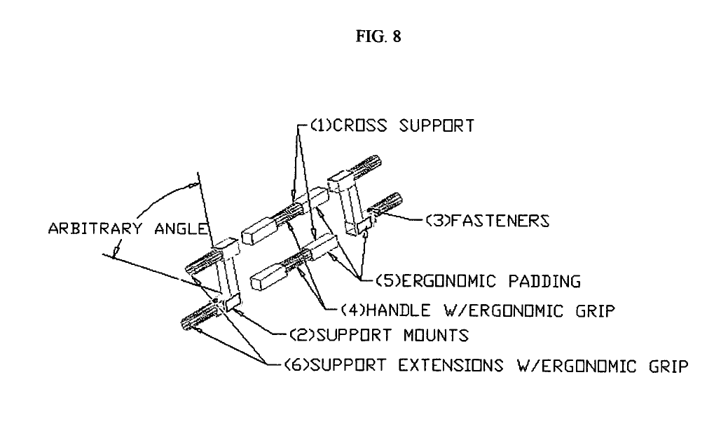

FIG. 8 is a detailed isometric exploded view of the dual-stacked and extended cross support system, this view shows the unit exploded and separated from the wheelbarrow handles. The stacked (1) CROSS SUPPORT is made of variable rigidity, can be scaled in size to withstand desired load requirements, is located at an arbitrary angle and distance to the (2) SUPPORT MOUNTS, can have (5) ERGONOMIC PADDING and is mounted arbitrarily with (2) SUPPORT MOUNTS to the wheelbarrows handles with (3) FASTENERS. The center (4) HANDLE is formed into the said (1) CROSS SUPPORT and the (6) SUPPORT EXTENSIONS W/ERGONOMIC GRIP are either formed into the (1) CROSS SUPPORT or are added to the (2) SUPPORT MOUNTS and set at an arbitrary angle, spherically locatable relative to design requirements.

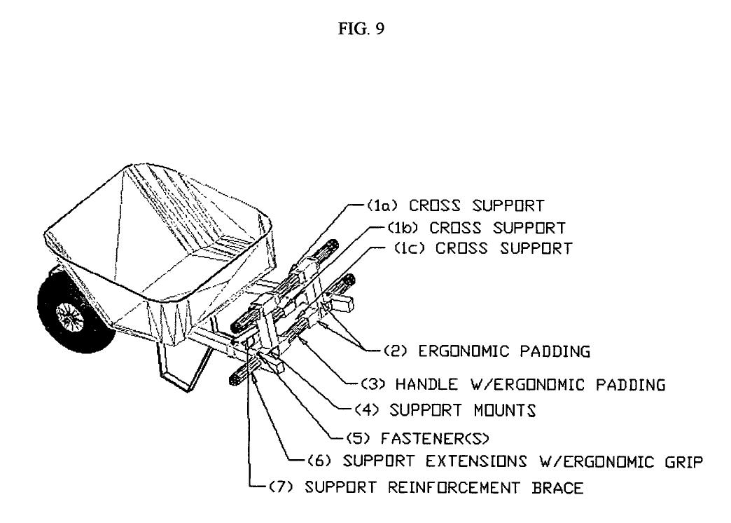

FIG. 9 is a detailed perspective drawing of the wheelbarrow with the unit installed using a dual-stacked, extended and support reinforced cross support. The handle conversion unit is shown mounted to the original handles supplied with the wheelbarrow and can be covered with (2) ERGONOMIC PADDING. The stacked (1a, 1b, 1c) CROSS SUPPORT is made of variable rigidity, can be scaled in size to withstand desired load requirements, is located at an arbitrary angle to the wheelbarrow handles and it is fastened arbitrarily using (4) SUPPORT MOUNTS to the wheelbarrows handles with (5) FASTENERS. The (1a) CROSS SUPPORT is reinforced by (7) SUPPORT REINFORCEMENT BRACE(S) which can be arbitrarily mounted to (5) SUPPORT MOUNTS, (1b) CROSS SUPPORT, or through mounting to or fabricated within the wheelbarrow handles. The center (3) HANDLE W/ERGONOMIC GRIP is formed into the said (1) CROSS SUPPORT and the (6) SUPPORT EXTENSIONS W/ERGONOMIC GRIP are either formed into the (1) CROSS SUPPORT, added to the (2) SUPPORT MOUNTS, or are fabricated and formed into the wheelbarrow handles.

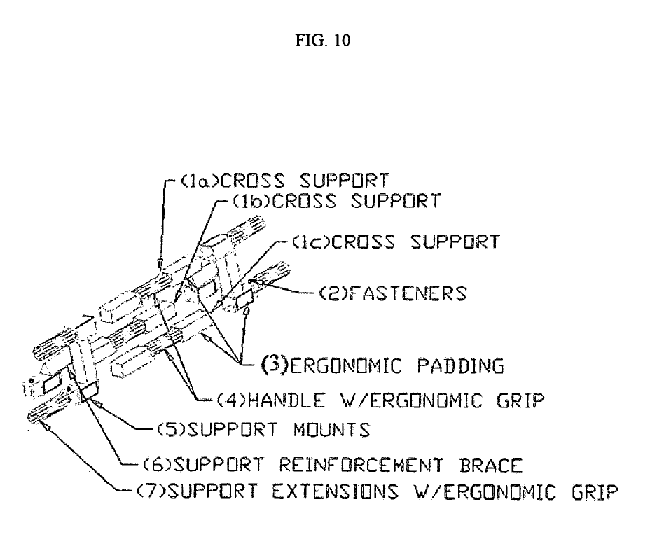

FIG. 10 is a detailed isometric exploded view of the wheelbarrow with the unit installed using a dual-stacked, extended and support reinforced cross support, this view shows the unit exploded and separated from the wheelbarrow handles. The handle conversion unit as shown can be covered with (5) ERGONOMIC PADDING. The stacked (1a, 1b, 1c) CROSS SUPPORT is made of variable rigidity, can be scaled in size to withstand desired load requirements, is located at an arbitrary angle to the wheelbarrow handles and it is fastened arbitrarily using (4) SUPPORT MOUNTS to the wheelbarrows handles with (5) FASTENERS. The (1a) CROSS SUPPORT is reinforced by (7) SUPPORT REINFORCEMENT BRACE(S) which can be arbitrarily mounted to (5) SUPPORT MOUNTS, (1b) CROSS SUPPORT, or through mounting to or fabricated within the wheelbarrow handles. The center (3) HANDLE W/ERGONOMIC GRIP is formed into the said (1) CROSS SUPPORT and the (6) SUPPORT EXTENSIONS W/ERGONOMIC GRIP are either formed into the (1) CROSS SUPPORT, added to the (2) SUPPORT MOUNTS, or are fabricated and formed into the wheelbarrow handles.

The invention claimed is:

1. A wheelbarrow comprising: a frame including an elongated pair of handles and a center handle, a pan attached to said frame, a cross support structure connected to said frame, said support structure further comprising one or more cross beams, one of said cross beams including an ergonomic pad, said pad allowing a user to safely apply thrust to the wheelbarrow in an uphill or frontward path by placing the thighs of said user against said pad.

2. The wheelbarrow recited by claim 1, wherein the center handle can be removable.

3. The wheelbarrow recited by claim 1, wherein the center handle is made to interchange with other handle designs.

4. The wheelbarrow recited by claim 1, wherein the center handle can be locked/unlocked in place with the elongated pair of handles.

5. The wheelbarrow recited by claim 1, wherein the cross support(s) can be designed as single or multiple members.

6. The wheelbarrow recited by claim 1, wherein the cross support(s) are extendable beyond the said elongated pair of handles.

7. The wheelbarrow recited by claim 1, wherein the cross support(s) can be located relative to any angle of the said elongated pair of handles.

8. The wheelbarrow recited by claim 1, wherein the cross support(s) extensions can be padded for ergonomic user benefits.

9. The wheelbarrow recited by claim 1, wherein the cross support(s) extensions can be part of the cross support or separate.

10. The wheelbarrow recited by claim 1, wherein the cross support(s) mounts can be reinforced by linkage(s) between one or more support mounts.
